(19) United States
(12) Patent Application Publication
(10) Pub. No.: US 2013/0339977 A1
(43) Pub. Date: Dec. 19, 2013

(54) MANAGING TASK LOAD IN A MULTIPROCESSING ENVIRONMENT

(71) Applicants: Jack B. Dennis, Cambridge, MA (US); Xiao X. Meng, Sunnyvale, CA (US)

(72) Inventors: Jack B. Dennis, Cambridge, MA (US); Xiao X. Meng, Sunnyvale, CA (US)

(21) Appl. No.: 13/915,129

(22) Filed: Jun. 11, 2013

Related U.S. Application Data
(60) Provisional application No. 61/661,412, filed on Jun. 19, 2012.

(51) Int. Cl. G06F 9/50

(52) U.S. Cl. CPC G06F 9/5083
USPC 718/105

(57) ABSTRACT

Managing load in a set of multiple processing modules interconnected by an interconnection network includes: communicating with each of the processing modules in the set, from a load management unit, over respective communication channels that are independent from the interconnection network. In a memory of the load management unit, information is stored indicative of quantities of tasks assigned for execution by respective ones of the processing modules in the set. The load management unit communicates with processing modules in the set over the communication channels to request reassignment of tasks for execution by different processing modules based at least in part on the stored information.

This application claims the benefit of U.S. Provisional Application No. 61/661,412, titled “MANAGING TASK LOAD IN A MULTIPROCESSING ENVIRONMENT,” filed Jun. 19, 2012, incorporated herein by reference.

### STATEMENT AS TO FEDERALLY SPONSORED RESEARCH

This invention was made with government support under Contract No. CCF-0937907 awarded by the National Science Foundation. The government has certain rights in the invention.

### BACKGROUND

This description relates to managing task load in a multiprocessing environment.

In some multiprocessing environments, such as integrated circuits having multiple processing cores, various techniques are used to distribute tasks for execution by the processing cores. In some techniques, tasks assigned for execution by one processing core can be reassigned for execution on a different processing core (e.g., for load balancing). For example, runtime software, which executes on the processing cores while the tasks are being executed, may enable messages to be exchanged among the processing cores to reassign tasks.

### SUMMARY

In one aspect, in general, an apparatus includes: a plurality of processing modules; an interconnection network coupled to at least some of the processing modules including a set of multiple of the processing modules; and a load management unit coupled to each of the processing modules in the set over respective communication channels that are independent from the interconnection network. The load management unit includes: memory configured to store information indicative of quantities of tasks assigned for execution by respective ones of the processing modules in the set, and circuitry configured to communicate with processing modules in the set over the communication channels to request reassignment of tasks for execution by different processing modules based at least in part on the stored information.

Aspects can include one or more of the following features.

Each of the processing modules in the set includes memory configured to store an associated queue of tasks assigned for execution by that processing core.

Each of the processing modules in the set is configured to send information indicative of a number of tasks stored in the associated queue to the load management unit over one of the communication channels.

Each of the processing modules in the set is configured to respond to a request to reassign a task for execution on an identified processing module by sending information sufficient to execute a task in the associated queue to the identified processing module over the interconnection network.

The processing modules in the set comprise cores in a multicore processor.

The processing modules in the set comprise nodes in a hierarchical system, where each node includes a load management unit coupled to each of multiple cores in a multicore processor over respective communication channels that are independent from an interconnection network interconnecting the cores.

In another aspect, in general, a method for managing load in a set of multiple processing modules interconnected by an interconnection network includes: communicating with each of the processing modules in the set, from a load management unit, over respective communication channels that are independent from the interconnection network; storing, in a memory of the load management unit, information indicative of quantities of tasks assigned for execution by respective ones of the processing modules in the set; and communicating with processing modules in the set over the communication channels to request reassignment of tasks for execution by different processing modules based at least in part on the stored information.

Aspects can have one or more of the following advantages.

Use of a load management unit enables increased performance and energy efficiency, and the ability to achieve fine-grain multitasking for multiprocessing environments, including massively parallel systems. The centralized determination of when a particular overloaded processing core should send one or more tasks to a designated processing core enables the load management unit to incorporate load information from each of the processing cores into that determination. The independent communication channels prevent other communication among the processing cores from interfering with the requests from the load management unit, which may be critical for ensuring fast dynamic management of task load among the processing cores. Having one or more transmission lines dedicated to transmission of signals between the load manager and a particular processing core also prevents the requests from the load management unit from interfering with other communication among the processing cores.

Other features and advantages of the invention are apparent from the following description, and from the claims.

### DESCRIPTION OF DRAWINGS

FIG. 1 is a schematic diagram of a multicore processor with a domain load manager.

FIG. 2 is a schematic diagram of a domain load manager.

FIG. 3 is a schematic diagram of a multicore processor with a domain load manager.

FIG. 4 is a schematic diagram of a hierarchical system with a hierarchy load manager.

FIG. 5 is a schematic diagram of a hierarchy load manager.

### DESCRIPTION

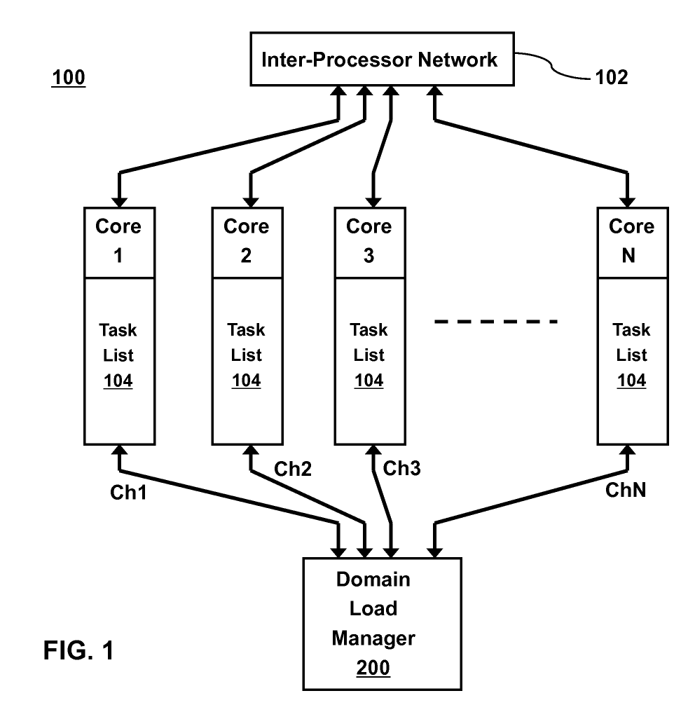

Referring to FIG. 1, a multicore processor 100 is an example of a multiprocessing system (e.g., a system on an integrated circuit) that is configured to use an efficient hardware mechanism to manage assignment of tasks, including determining when tasks should be reassigned. The processor 100 includes multiple processing cores in communication over an inter-processor network 102. The inter-processor network 102 is any form of interconnection network that enables communication between any pair of processing cores. For example, one form of interconnection network among the processing cores is a cross-bar switch that has input ports for receiving data from any of the cores and output ports for sending data to any of the cores, based on arrangements of its switching circuitry. Another form of interconnection network among the processing cores is a mesh network among individual switches connected to respective processing cores (e.g., in a rectangular arrangement with each core connected to at least two neighboring cores to its North, South, East, or West directions).

A group of N of the processing cores (Core 1, Core 2, Core 3, . . . , Core N) that forms a processing domain (which may include all of the processing cores in the processor 100 or fewer than all of the processing cores) are managed by a Domain Load Manager (DLM) 200, which is a hardware unit that is separate from the N processing cores in the domain. The DLM 200 is coupled to each of the N processing cores over respective communication channels (Ch1, Ch2, Ch3, . . ., ChN) that, in some implementations, are independent from the inter-processor network 102. The communication channel between a particular processing core and the DLM 200 may include any number of physical signal transmission lines, for example, for transmitting digital signals. In some implementations, each of the N processing cores in the group being managed has a separate dedicated set of one or more transmission lines between it and the DLM 200.

The DLM 200 stores load information from the processing cores that indicates a quantity of tasks that are assigned for execution by that processing core. For example, each processing core stores a task list 104, and the count of the total number of tasks in the task list 104 is repeatedly sent to the DLM 200 (e.g., continuously or at regular intervals of time, or in response to a large enough change in the size of the task list 104). The DLM 200 analyzes the received load information (or other information provided by the processing core) and assigns a processing core with available tasks to supply a task for execution by a target core with capacity to accept an available task (in some implementations, the target core may request an available task, but it is the DLM 200 that determines based on the information in the task list 104 of each processing core when to assign tasks). In this manner, tasks that were originally assigned for execution by a particular processing core (e.g., a task stored in memory associated with a particular processing core) are available for execution by any processing core.

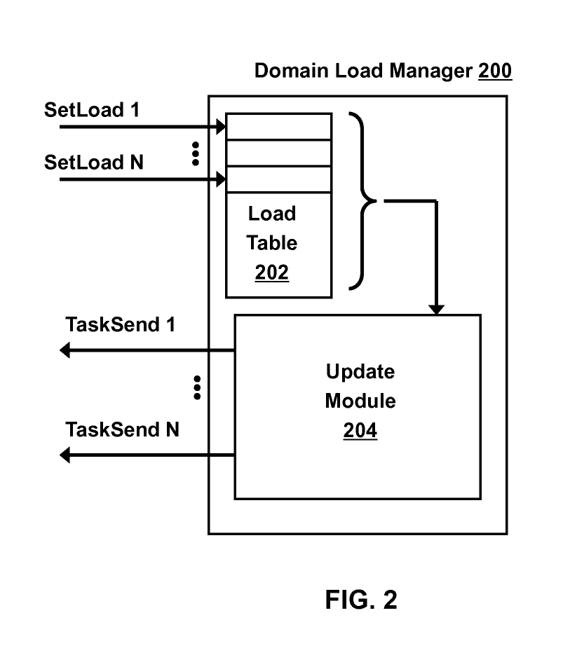

FIG. 2 shows an example of the DLM 200. In this example, the DLM 200 includes memory configured to store information indicative of quantities of assigned tasks (e.g., tasks in respective processing cores' task lists) in a load table 202. Direct communication channels Ch1-ChN over which the processing cores communicate with the DML 200 (independent of communication over the inter-processor network) include N SetLoad channels (SetLoad 1-SetLoad N) over which the processing cores send a current load representing a number of assigned tasks. The DLM 200 includes an update module 204 with circuitry configured to read the load table 202 and communicate with the processing cores over N TaskSend communication channels (TaskSend 1-TaskSend N).

The update module 204 analyzes the information in the load table 202 (e.g., using combinational logic) to determine which processing core(s) should send one or more tasks to another processing core to balance the overall load. For example, the update module 204 determines which processing core has the largest number of assigned tasks and which processing core has the least number of assigned tasks. When the difference between these numbers of tasks is larger than a threshold, the update module sends a message to request reassignment of tasks over the TaskSend channel of the highest-loaded processing core that identifies the least-loaded processing core. The threshold may be a threshold that is determined before execution of a program, or a threshold determined and/or dynamically adjusted during execution of a program. In some implementations, the message also includes a number of tasks to be reassigned. In response to the message, the highest-loaded processing core sends a task in its task list 104 to the least-loaded processing core (or a Task Record containing information sufficient for executing the task) over the inter-processor network 102. The least-loaded processing core receives the reassigned task and adds the task to its task list 104. Other techniques can be used by the update module 204 to determine which processing core will send a reassigned task and which processing core will receive the reassigned task. For example, criteria can be used to rank processing cores by their load and additional factors (e.g., the rate at which a processing core's load is changing). The update module 204 can also be configured to make reassignment decisions based on information about an affinity between particular tasks and a “distance” between two particular processing cores (e.g., there may tasks that should be performed on processing cores that are “near” each other with respect to their ability to communicate with low latency over the inter-processor network 102). Some of the information for determining these additional factors can be communicated over the independent channels Ch1-ChN in addition to the SetLoad signals, such as signals that provide an estimate of a rate at which a processing core's load is changing. In some cases some load imbalance will be tolerated between some processing cores for various reasons.

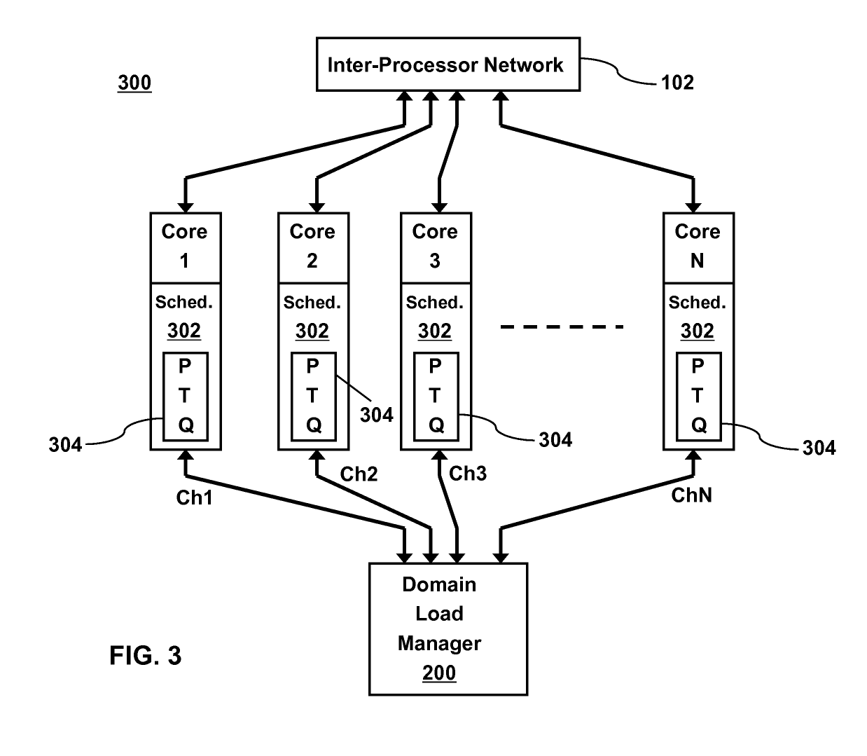

Referring to FIG. 3, a multicore processor 300 is another example of a multiprocessing system. In this example, each processing core includes a local hardware scheduler 302 that maintains a work queue of tasks. A Domain Load Manager (DLM) 200 interacts with the local scheduler 302 of each processing core over respective communication channels Ch1-ChN.

Each processing core includes a memory element that holds its queue of tasks waiting for execution, illustrated in this example as the Pending Task Queue (PTQ) 304. Each entry in the PTQ 304 is a Task Record that contains information sufficient to initiate execution of the task on any processing core in the set over which load balancing is to be performed. The Task Record can be configured to include a variety of information for initiating execution of a task, including for example, a task description and inputs for the task or other data or pointers to data for executing the task.

The processing core, through the scheduler 302, adds a new entry to the PTQ 304 when it creates a task, for example, through execution of a spawn instruction. When a task the processing core is executing terminates, the scheduler 302 removes an entry from the PTQ 304 and begins its execution. If the Task Queue is empty when the processing core executes a quit instruction, that processing core becomes idle until it is given work by some external agent.

Referring again to FIG. 2, the update module 204 controls the TaskSend signals according to the current load distribution in the Domain as measured by entries in the Load Table 202. One possible update procedure is:

Step 1. Compute the average load per processing core.

Step 2. Construct a list of processing cores with greater than average load, ordered by the amount of excess load.

Step 3. Construct a list of processing cores with less than average load, ordered by amount of deficient load.

Step 4. Select pairs (A,B) from the two lists, starting with the pair with the largest discrepancy of load, and continuing until the largest difference is too small to be worth acting on.

Step 5. For each pair, send over the TaskSend signal for processing core B the index of processing core A.

Step 6. Set the Task Send signal for each processing core not the second member of any selected pair to null.

Steps 1 through 4 may be implemented, for example, by a combinational logic block of the update module 204. The logic can be made relatively simple if the measure of load in the Load Table 202 is an approximate representation of the actual load.

A scheme for hierarchical implementation of work reassignment is scalable to massively parallel systems with thousands of processing cores. A large multiprocessor computer system may contain many thousands of processing cores, such that it is impractical to implement the described work reassignment scheme for a processor Domain consisting of all processing cores. For such a system, task reassignment may be implemented using a hierarchy of domains. The lowest level domain might be the collection of processing cores (or a portion of the processing cores) built into a single multi-core chip. Higher levels might correspond to the physical structure of large systems such as a circuit board, rack, or cabinet of computing nodes.

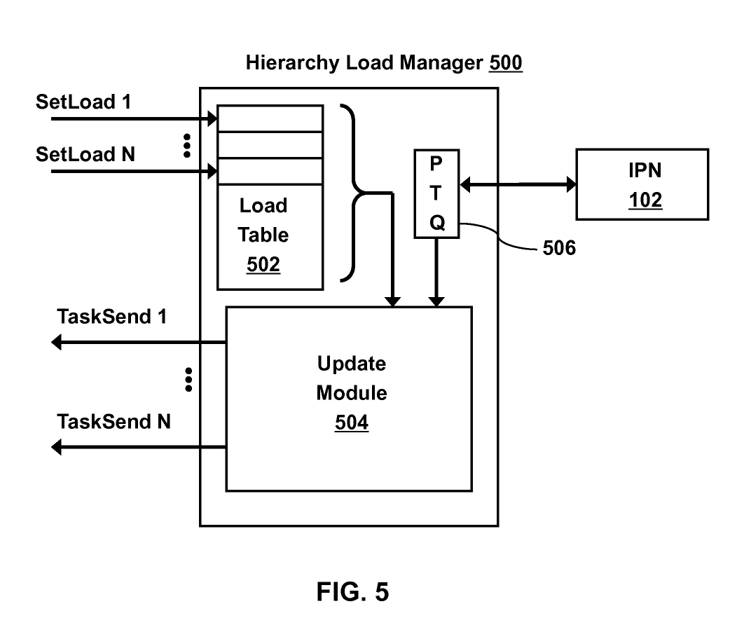

Hierarchical work reassignment can be performed by the arrangement of components shown in FIG. 5, which shows a single level 500 of what could be a multi-level hierarchy of processing domains. Each of the lower level domains (Domain 1-Domain N) includes a Hierarchy Load Manager (HLM) 500 that operates similar to the DLM 200 as described above, with a Load Table 502, and an update module 504, as shown in FIG. 5. The HLM 500 also includes a domain Pending Task Queue (PTQ) 506 that holds Task Records of excess tasks of the domain that may be stolen for execution in other domains. This PTQ 506 is connected to the inter-processor network 102, like the processing cores in the domain. The tasks represented in this PTQ 506 are available for reassignment by other domains, as well as by processing cores in its domain.

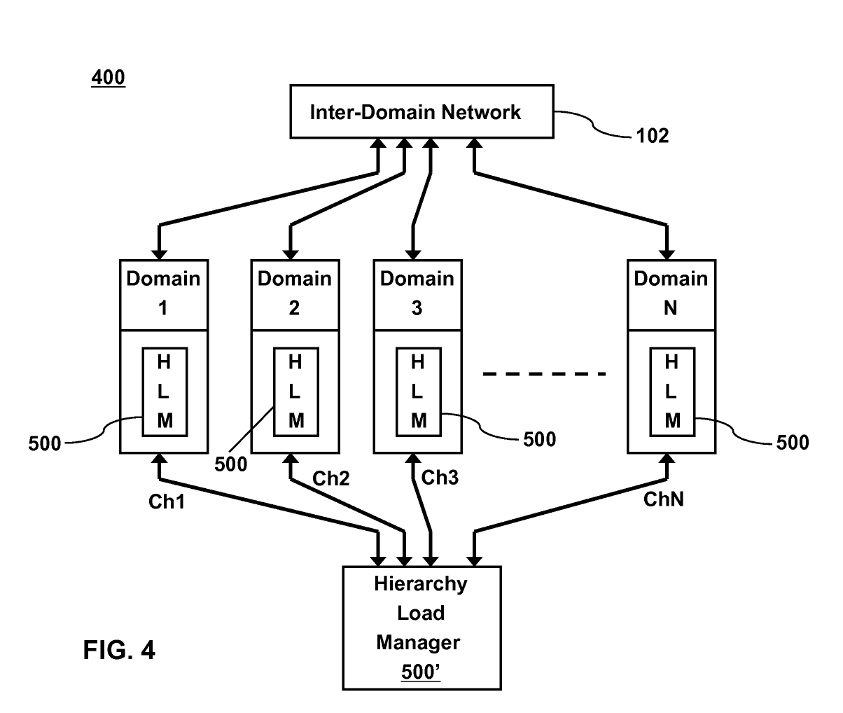

Referring again to FIG. 4, hierarchical task reassignment among the lower level domains (Domain 1-Domain N) of the level 500 is managed by a Hierarchy Load Manager 500′ using a protocol for interacting with the HLMs 500 of the lower level domains similar to that used by the domain DLM 200 for interacting with domain processing cores.

It is to be understood that the foregoing description is intended to illustrate and not to limit the scope of the invention, which is defined by the scope of the appended claims. Other embodiments are within the scope of the following claims.

What is claimed is:

1. An apparatus, comprising:
a plurality of processing modules;
an interconnection network coupled to at least some of the processing modules including a set of multiple of the processing modules; and
a load management unit coupled to each of the processing modules in the set over respective communication channels that are independent from the interconnection network, the load management unit including
memory configured to store information indicative of quantities of tasks assigned for execution by respective ones of the processing modules in the set, and
circuitry configured to communicate with processing modules in the set over the communication channels to request reassignment of tasks for execution by different processing modules based at least in part on the stored information.

2. The apparatus of claim 1, wherein each of the processing modules in the set includes memory configured to store an associated set of tasks assigned for execution by that processing core.

3. The apparatus of claim 2, wherein each of the processing modules in the set is configured to send information indicative of a number of tasks stored in the associated set of tasks to the load management unit over one of the communication channels.

4. The apparatus of claim 2, wherein each of the processing modules in the set includes circuitry configured to respond to a request to reassign a task for execution on an identified processing module by sending information sufficient to execute a task in the associated set of tasks to the identified processing module over the interconnection network.

5. The apparatus of claim 2, wherein each of the processing modules in the set includes circuitry configured to respond to a request to reassign a task for execution on an identified group of processing modules by sending information sufficient to execute a task in the associated set of tasks to a processing module in the identified group of processing modules over the interconnection network.

6. The apparatus of claim 1, wherein each communication channel for a respective processing modules in the set comprises a different set of one or more transmission lines between that processing module and the load management unit.

7. The apparatus of claim 1, wherein the processing modules in the set comprise cores in a multicore processor.

8. The apparatus of claim 1, wherein the processing modules in the set comprise nodes in a hierarchical system, where each node includes a load management unit coupled to each of multiple cores in a multicore processor over respective communication channels that are independent from an interconnection network interconnecting the cores.

9. A method for managing load in a set of multiple processing modules interconnected by an interconnection network, the method comprising:
communicating with each of the processing modules in the set, from a load management unit, over respective communication channels that are independent from the interconnection network;
storing, in a memory of the load management unit, information indicative of quantities of tasks assigned for execution by respective ones of the processing modules in the set; and
communicating with processing modules in the set over the communication channels to request reassignment of tasks for execution by different processing modules based at least in part on the stored information.

10. The method of claim 9, wherein each of the processing modules in the set stores an associated set of tasks assigned for execution by that processing core.

11. The method of claim 10, wherein each of the processing modules in the set sends information indicative of a number of tasks stored in the associated set of tasks to the load management unit over one of the communication channels.

12. The method of claim 10, wherein each of the processing modules in the set responds to a request to reassign a task for execution on an identified processing module by sending information sufficient to execute a task in the associated set of tasks to the identified processing module over the interconnection network.

13. The method of claim 10, wherein each of the processing modules in the set responds to a request to reassign a task for execution on an identified group of processing modules by sending information sufficient to execute a task in the associated set of tasks to a processing module in the identified group of processing modules over the interconnection network.

14. The method of claim 9, wherein each communication channel for a respective processing modules in the set uses a different set of one or more transmission lines between that processing module and the load management unit.

15. The method of claim 9, wherein the processing modules in the set comprise cores in a multicore processor.

16. The method of claim 9, wherein the processing modules in the set comprise nodes in a hierarchical system, where each node includes a load management unit coupled to each of multiple cores in a multicore processor over respective communication channels that are independent from an interconnection network interconnecting the cores.
